(19) United States
(12) Patent Application Publication
(10) Pub. No.: US 2022/0277663 A1
(43) Pub. Date: Sep. 1, 2022

(54) Guided Learning Systems, Devices, and Methods

(71) Applicants: Justin A Tehrani, Seattle, WA (US); Madeleine R. Tehrani, Seattle, WA (US)

(72) Inventors: Justin A Tehrani, Seattle, WA (US); Madeleine R. Tehrani, Seattle, WA (US)

(21) Appl. No.: 17/187,487

(22) Filed: Feb. 26, 2021

(51) Int. Cl. G09B 19/00; A63B 71/06; A63B 24/00

(52) U.S. Cl. CPC G09B 19/0015; A63B 71/0622; A63B 24/0006; A63B 2244/22; A63B 2220/836; A63B 2071/0625; A63B 2071/0655; A63B 2220/62; A63B 2230/62; A63B 2220/05; A63B 2220/40; A63B 2220/12; A63B 2220/18; A63B 2220/803; A63B 2024/0015

(57) ABSTRACT

Systems, devices, and methods are described for providing, among other things, a real-time feedback to novice dance associated spotting, center of gravity, timing, etc. The disclosed technologies and methodologies include a spotter unit configured to generate a time sequence of pixel images associate with a performance event and to generate position information, movement information, timing information, or the like associated with a performance event, In an embodiment, the disclosed technologies and methodologies include a trainer unit configured to compare the position, movement, timing information, or the like associated with the performance event to user-specific target position information, user-specific target movement information, or user-specific target timing position information, and to provide one or more instances of a fidelity status associated with the performance event.

This application claims the benefit of priority under 35 USC .sctn. 119(e) of U.S. Provisional Patent Application No. 63/045,148 filed Jun. 28, 2020, the contents of which are incorporated herein by reference in their entirety.

### SUMMARY

In an aspect, the present disclosure is directed to, among other things, a system including a spotter unit configured to generate a time sequence of pixel images associated with a performance event and to generate position information, movement information, or timing information associated with the performance event. In an embodiment, the system includes a trainer unit configured to compare the position, movement, or timing information associated with the performance event to user-specific target position information, user-specific target movement information, or user-specific target timing position information, and to provide one or more instances of a fidelity status associated with the performance event.

In an aspect, the present disclosure is directed to, among other things, a digital spotting feedback method including extracting time sequence of rotational movements to perform a turn. This includes hand position, head position, torso rotation, timing of head rotation relative to body rotation, accuracy relative to 360° rotation, balance and relative timing of the sequence of movements from one or more sensors associated with a performance event. In an embodiment, the digital spotting feedback method includes generating a virtual display including one or more instances of position information, movement information, or timing information associated with the performance event. In an embodiment, the digital spotting feedback method includes comparing one or more of the position information, movement information, or timing information associated with the performance event to user-specific target position information, user-specific target movement information, or user-specific target timing position. In an embodiment, the digital spotting feedback method includes generating a virtual display including one or more instances of a fidelity status associated with the performance event.

In an aspect, the present disclosure is directed to, among other things, a method including acquiring position information from a plurality of spotter elements. In an embodiment, the method includes predicting a position of a portion of a body of a user responsive to acquiring position information from a plurality of spotter elements. In an embodiment, the method includes generating one or more instances of a first reference position on a virtual display based one or more parameters associated with predicting the position of the portion of the body of the user.

### BRIEF DESCRIPTION OF THE FIGURES

FIG. 1 is a schematic diagram of a guided learning system according one embodiment.

FIG. 2 is a schematic diagram of guided learning system including one or more spotter elements according one embodiment.

FIG. 3 is a schematic diagram of a guided learning system including user feedback according one embodiment.

FIG. 4A is a schematic diagram of a guided learning system including calibration algorithm according one or more embodiments.

FIG. 4B is a flow diagram of a guided learning system including analysis algorithm according one or more embodiments.

FIG. 5 is a schematic diagram of a guided learning system including comparison information according one embodiment.

FIG. 6 is a schematic diagram of a guided learning system according one embodiment. In the environment, the figure shows visualizations of feedback provided to the dancer or ensemble on performance based on physics calculations compared to ideal.

FIGS. 7A-7B is a schematic diagram of a guided learning system according one or more embodiments.

FIG. 8 shows a schematic diagram of a guided learning system deployed inside a dance studio receiving input from one or more remote sensors

FIG. 9 shows a flow diagram of a digital spotting feedback method according to one embodiment.

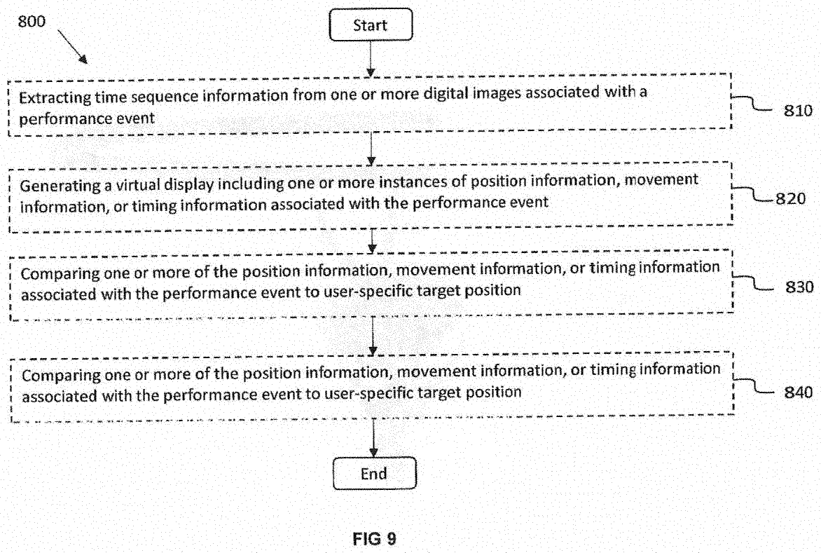

FIG. 10 shows a flow diagram of a method according to one embodiment.

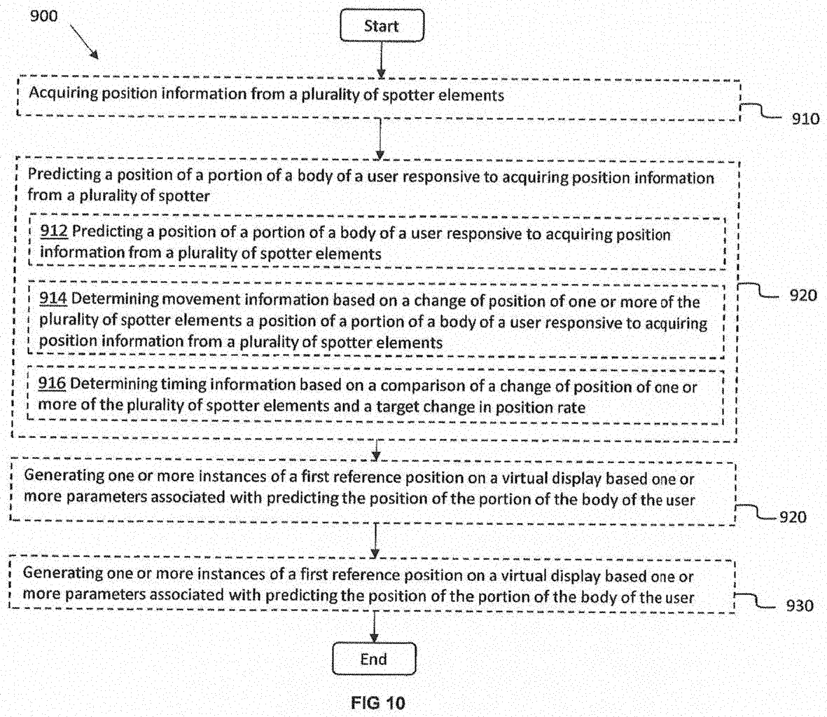

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here.

### DETAILED DESCRIPTION

In an embodiment, the disclosed technologies and methodologies are directed to a guided learning system that provides virtual and digital guidance, and technological support for novice dancers to help them improve their technique and enhance their dancing capabilities. For example, in an embodiment, image tracking, machine learning, artificial intelligence, pattern recognition and digital content are used to provide real-time feedback for spotting, center of inertia, movement and timing, body placement and posture.

In an embodiment, individual users can use the technology to practice on their own or as part of a dance class environment. In an embodiment, when used in a group environment, the teacher and students are presented with visual results and virtual representation including statistics and motion simulation indicative of their progress and motion relative to one another to help the class practice for a performance. In an embodiment, visual results and virtual representation include one or more instances of relative comparisons with other dancers or a target digital representation wireframe to assist users to improve overall synchronicity, turns, leaps, and maintain spacing among the dancers in a way that is fun, engaging, encouraging and positive.

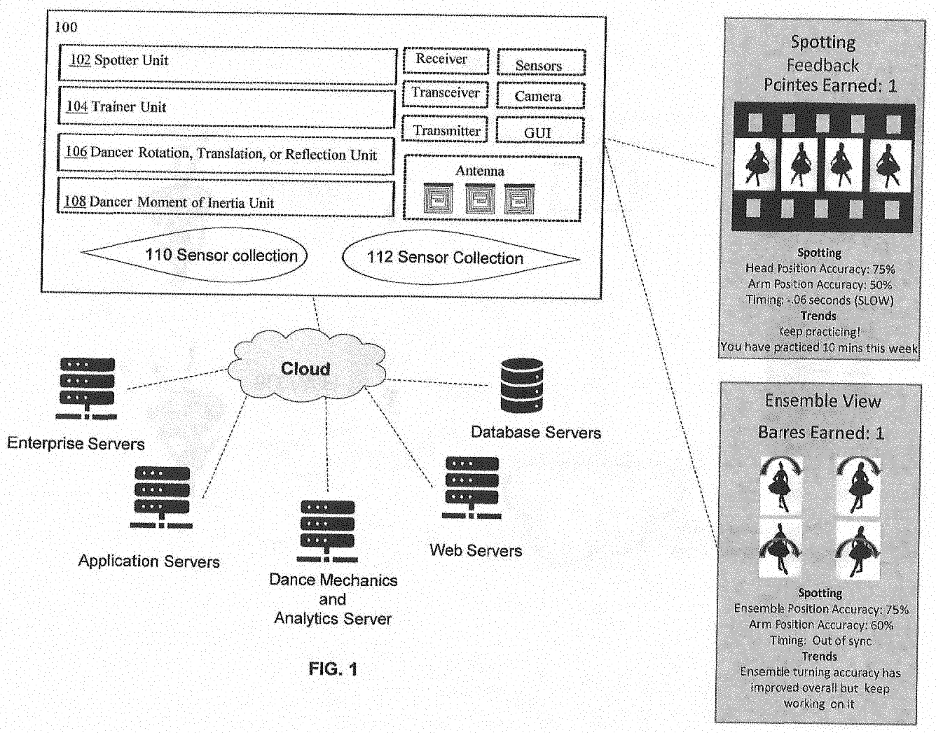

Accordingly, FIG. 1 show a system 100 in which one or more methodologies or technologies can be implemented such as, for example, providing digital spotting feedback, tracking a center of inertia, mass, gravity, etc., providing movement and timing information, analyzing body placement and posture, and the like. In an embodiment, the system 100 includes a spotter unit 102 and a trainer unit 104.

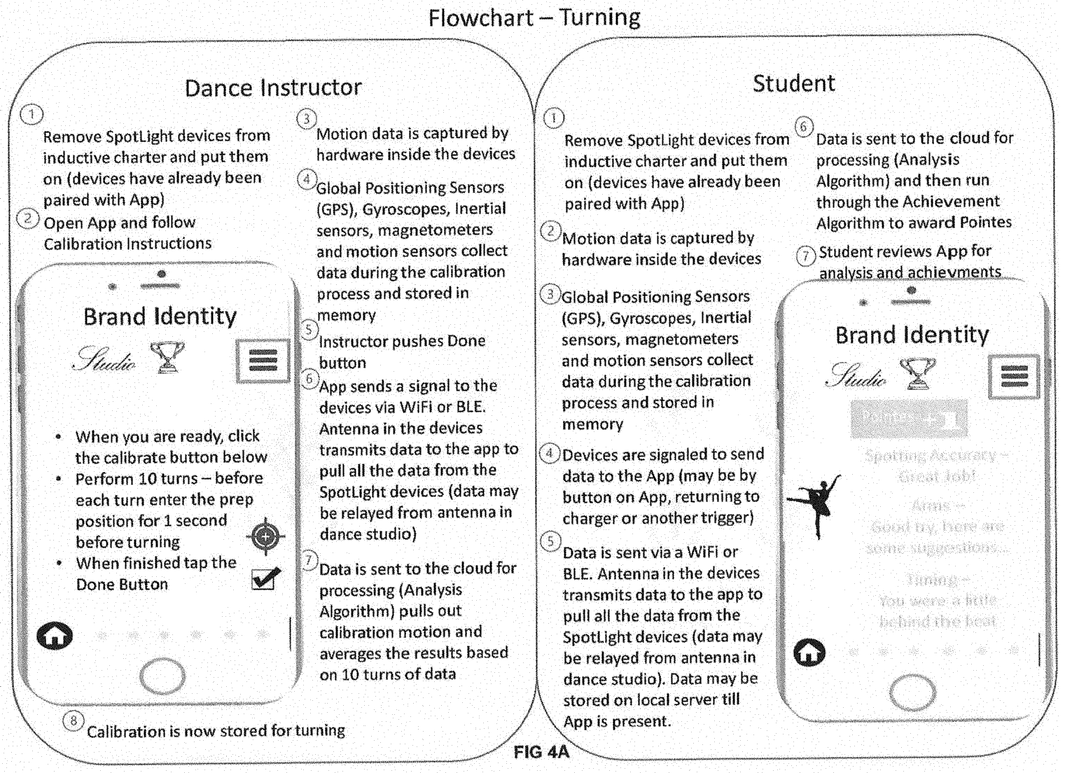

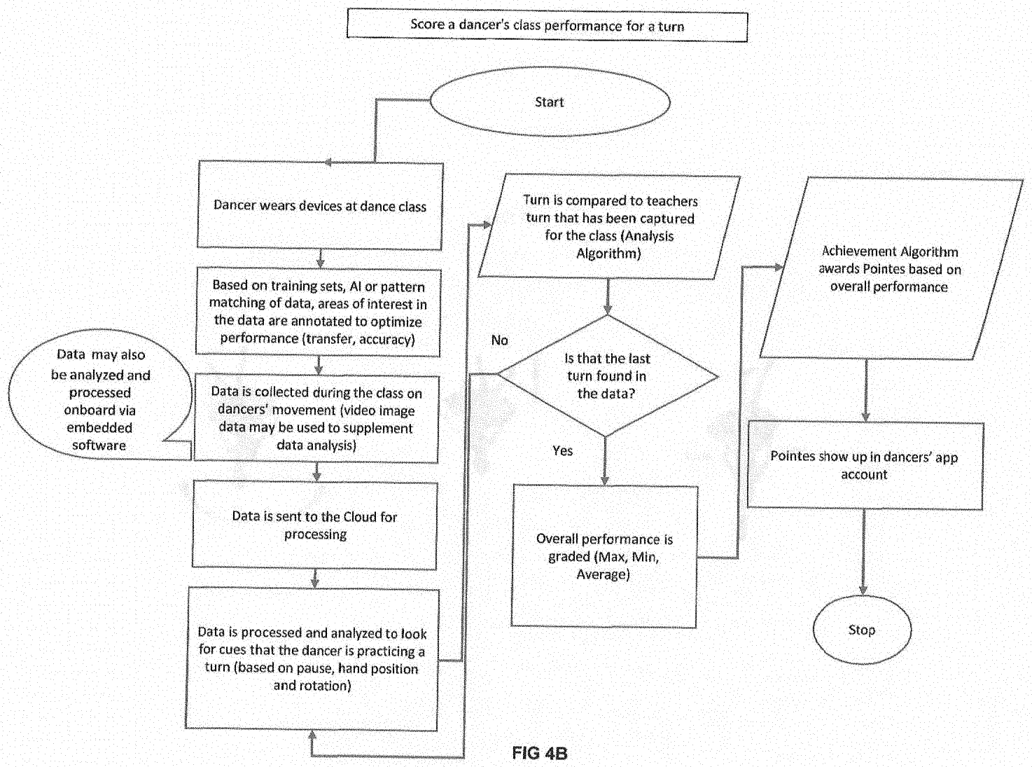

In an embodiment, during operation, the spotter unit 102 include processing circuitry configured to collect digital spotting feedback, tracking a center of inertia, mass, gravity, etc., providing movement and timing information, analyzing body placement and posture, and the like. In an embodiment, the data is compiled in real-time or post processed and the trainer unit 104 provides “on the fly” feedback to the dancer of their position using the data from the spotter unit 102 and ambient data such as audio, video or the like with the Performance Analysis (FIG. 4B). In an embodiment the feedback is all provided post completion of session to not distract the dance instruction.

In an embodiment, information is transmitted to a device through a wireless communication channel. Using Training algorithms based on calibration completed by the dance teacher prior to the class (FIG. 4A) it analyzes the data from the dancer's performance and provides visualization of the results to guide the dancer to improved performance.

In an embodiment, as part of the analysis, system 100 includes processing circuitry configured to compares results of a dancer's performance and to generate comparison information relative to a reference condition or target ideal and to generate one or more instances of a scores and a respective incentive. In an embodiment, an analysis is generated for an individual user to assess performance and progress. In an embodiment, an analysis is generated for an ensemble to assess performance and progress.

In an embodiment, the spotter unit 102 is configured to generate a time sequence of pixel images associated with a performance event and to generate position information, movement information, or timing information associated with a performance event. For example, in an embodiment, the spotter unit 102 comprises processing circuitry configured to track and assess a dancer's rotation, translation, or reflection associated with a performance event.

In an embodiment, processing circuitry includes, among other things, one or more computing devices such as a processor (e.g., a microprocessor), a central processing unit (CPU), a digital signal processor (DSP), an application-specific integrated circuit (ASIC), a field programmable gate array (FPGA), or the like, or any combinations thereof, and can include discrete digital or analog circuit elements or electronics, or combinations thereof. In an embodiment, processing circuitry includes one or more ASICs having a plurality of predefined logic components. In an embodiment, processing circuitry includes one or more FPGA having a plurality of programmable logic components.

In an embodiment, processing circuitry includes one or more remotely located components. In an embodiment, remotely located components are operably coupled via wireless communication. In an embodiment, remotely located components are operably coupled via one or more receivers, transceivers, or transmitters, or the like.

In an embodiment, processing circuitry includes one or more memory devices that, for example, store instructions or data. For example, in an embodiment, processing circuitry includes one or more memory devices that store dancer rotation, translation, or reflection data. In an embodiment, processing circuitry includes one or more memory devices that store force, energy, momentum, inertia, velocity, or acceleration information associated with a moving human body.

Non-limiting examples of one or more memory devices include volatile memory (e.g., Random Access Memory (RAM), Dynamic Random Access Memory (DRAM), or the like), non-volatile memory (e.g., Read-Only Memory (ROM), Electrically Erasable Programmable Read-Only Memory (EEPROM), Compact Disc Read-Only Memory (CD-ROM), or the like), persistent memory, or the like. Further non-limiting examples of one or more memory devices include Erasable Programmable Read-Only Memory (EPROM), flash memory, or the like. The one or more memory devices can be coupled to, for example, one or more computing devices by one or more instructions, data, or power buses.

In an embodiment, processing circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In an embodiment, processing circuitry includes one or more user input/output components that are operably coupled to at least one computing device to control (electrical, electromechanical, software-implemented, firmware-implemented, or other control, or combinations thereof) at least one parameter associated with, for example, generating a user interface presenting a rating menu and receive one or more inputs indicative of a rating associated with the event based on the rating menu.

In an embodiment, processing circuitry includes a computer-readable media drive or memory slot that is configured to accept signal-bearing medium (e.g., non-transitory, tangible computer readable storage medium, computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as a magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., receiver, transceiver, or transmitter, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD—RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

In an embodiment, processing circuitry includes computing circuitry, memory circuitry, electrical circuitry, electro-mechanical circuitry, control circuitry, transceiver circuitry, transmitter circuitry, receiver circuitry, and the like. For example, in an embodiment, the spotter unit 102 comprises one or more of a computing device circuitry, memory circuitry, and at least one of transceiver circuitry, transmitter circuitry, and receiver circuitry.

In an embodiment, the spotter unit 102 comprises processing circuitry configured to assess, track, and analyze one or more of force, energy, momentum, inertia, velocity, and acceleration associated with a moving human body. For example, in an embodiment, the spotter unit 102 comprises processing circuitry configured to extract body part placement and movement information from a digital images using pixel by pixel analysis and to determine the angular moment associated with the moving human body.

In an embodiment, the spotter unit 102 comprises processing circuitry operably coupled to one or more sensors 110 operable to detect (e.g., assess, calculate, evaluate, determine, gauge, measure, monitor, quantify, resolve, sense, identify, or the like) one or more body parts or extremities. Non-limiting examples of sensors 110 include acoustic sensors, optical sensors, electromagnetic energy sensors, image sensors, photodiode arrays, charge-coupled devices (CCDs), complementary metal-oxide-semiconductor (CMOS) devices, transducers, optical recognition sensors, infrared sensors, radio frequency components sensors, thermo sensor, or the like. Further non-limiting examples of sensors 110 include accelerometers, global positioning sensors, gyroscopes, inclinometers, inertial sensors, magnetometers, moment of inertia sensors, motion sensors, or nodes.

In an embodiment, the spotter unit 102 comprises processing circuitry configured to detect, image, and track body parts associated with a dance move. For example, in an embodiment, the spotter unit 102 comprises processing circuitry including one or more optical sensor configured to determine the angular momentum associated with a dance move by tracking changes in position of one or more body parts or extremities, such in the performance of tour jeté, by detecting and tracking raising of the left leg, which is taken up by the trunk and arms, and then the left leg, and then then both legs, and determining the angular momentum using the principles of mechanics.

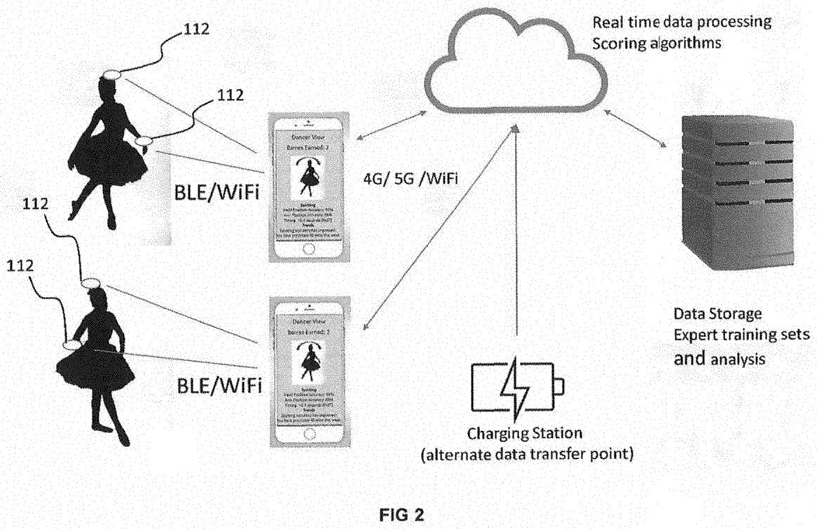

Referring to FIGS. 1 and 2, in an embodiment, the spotter unit 102 includes processing circuitry operably coupled to a plurality of spotter elements 112 adapted to be worn on a body of a user. Non-limiting examples of spotter elements 112 include accelerometers, global positioning sensors, gyroscopes, inclinometers, inertial sensors, magnetometers, moment of inertia sensors, motion sensors, nodes, or the like. Further non-limiting examples of spotter elements 112 include smart wearable devices including one or more accelerometers, global positioning sensors, gyroscopes, inclinometers, inertial sensors, magnetometers, moment of inertia sensors, motion sensors, nodes, or the like.

In an embodiment, the plurality of spotter elements 112 includes one or more accelerometers, global positioning sensors, gyroscopes, inclinometers, inertial sensors, magnetometers, moment of inertia sensors, motion sensors, or nodes. In an embodiment, plurality of spotter elements 112 includes one or more of a headband including one or more onboard sensors, a wristband including one or more onboard sensors, a leg band including one or more onboard sensors, or an article of clothing including one or more onboard sensors. In an embodiment, the plurality of spotter elements 112 includes one or more haptic or acoustic elements.

In an embodiment, the spotter unit 102 includes processing circuitry operably coupled to a plurality of spotter elements adapted to be worn on a body of a user, the spotter unit configured to acquire position information from the plurality of spotter elements. In an embodiment, the spotter unit 102 includes processing circuitry operably coupled to a plurality of spotter elements 112 adapted to be worn on a body of a user, the spotter unit configured to determine a position of a portion of the body of a user relative to one or more of the plurality of spotter elements and to generate one or more instances of a first reference position on a virtual display.

In an embodiment, the spotter unit 102 is configured to acquire position information from the plurality of spotter elements 112 and to determine a relative position of the plurality of spotter elements with respect to each other. In an embodiment, the spotter unit 102 is configured to acquire position information from the plurality of spotter elements 112 and to determine movement information based on a change of position of one or more of the plurality of spotter elements 112. In an embodiment, the spotter unit 102 is configured to acquire position information from the plurality of spotter elements and to determine timing information based on a comparison of a change of position of one or more of the plurality of spotter elements 112 and a target change in position rate.

In an embodiment, the spotter unit 102 includes processing circuitry configured to acquire movement information from a plurality of spotter elements 112 adapted to be worn on a body of a user. In an embodiment, the spotter unit 102 includes processing circuitry configured to acquire timing information from a plurality of spotter elements 112 adapted to be worn on a body of a user.

In an embodiment, the spotter unit 102 is configured to acquire position information from the plurality of spotter elements 112 and to generate posture or gesture information associated with the performance event based on the position information from the plurality of spotter elements 112. In an embodiment, the spotter unit 102 is configured to use information from one or more accelerometers, global positioning sensors, gyroscopes, inclinometers, inertial sensors, magnetometers, moment of inertia sensors, motion sensors, or nodes to generate location and orientation data of a user captured in the time sequence of pixel images associated with a performance event.

In an embodiment, during operation, a dancer ears one or more spotter elements 112 on various locations (e.g., head, ankle, arm, etc.). In an embodiment, system 100 captures data associated with a performance event, training event, etc. In an embodiment, data are relayed to a mobile device via Bluetooth Low Energy (BLE) or Wireless Fidelity (WiFi). In an embodiment, performance data is exchange with a cloud server which collects data from the activity which is captured in a database. In an embodiment, user movement data, performance event data, training event data, and the like, is analyses to assess the motion of the dancer, their body position and ability to keep in time with the music. In an embodiment, based on expert trained data that has already been captured in development “learning mode” it analyzes and grades the dancer's performance.

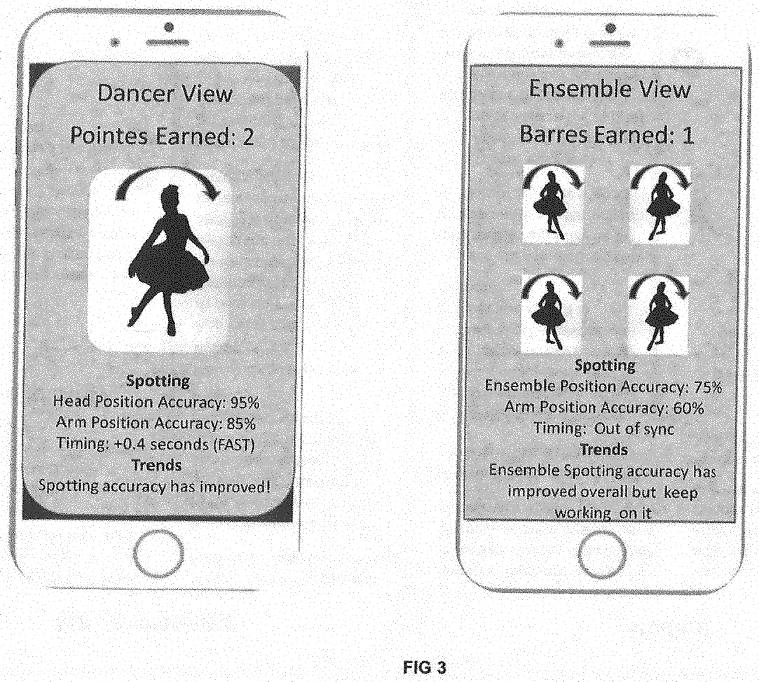

Referring to FIG. 3, in an embodiment, analysis information is relayed back to the app (Web Browser, mobile app . . . ) and the results are parsed and displayed based on the analysis completed. It then rewards points in the system known as “Pointes” and “Barres” depending on individual or group analysis. In an embodiment, system 100 includes circuitry configured to generate one or more instance of visualization of feedback associated with a performance based on comparison to ideal information.

Referring to FIGS. 1-3, In an embodiment, the trainer unit 104 is configured to compare the position, movement, or timing information associated with the performance event to user-specific target position information, user-specific target movement information, or user-specific target timing position information, and to provide one or more instances of a fidelity status associated with the performance event. In an embodiment, the trainer unit 104 is configured to generating an electrical control signal for controlling actuation of the at least one haptic element, optical element, or acoustic element associated with at least one of the plurality of spotter elements based on the comparison of the position, movement, or timing information associated with the performance event to user-specific target position, user-specific target movement information, or user-specific target timing position. In an embodiment, the trainer unit 104 is configured to generating an electrical control signal for controlling actuation of the at least one alarm based on the comparison of the position, movement, or timing information associated with the performance event to user-specific target position, user-specific target movement information, or user-specific target timing position.

In an embodiment, the trainer unit 104 is configured to generating an electrical control signal for controlling actuation of the at least one visual display based on the comparison of the position, movement, or timing information associated with the performance event to user-specific target position, user-specific target movement information, or user-specific target timing position. In an embodiment, the trainer unit 104 is configured to generating an electrical control signal for controlling actuation of the at least one piezo element based on the comparison of the position, movement, or timing information associated with the performance event to user-specific target position, user-specific target movement information, or user-specific target timing position.

Referring to FIG. 4, in an embodiment, system 100 includes circuitry configured to calibrate one or more of a spotter unit 102, a trainer unit 104, and the like based on a sequence of movements directing the dancer make predefined movements and calculating using physics data.

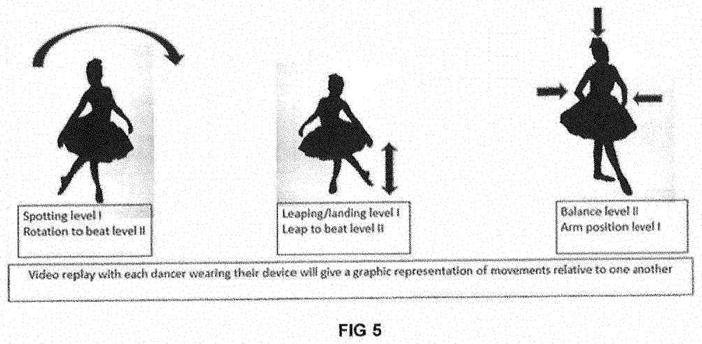

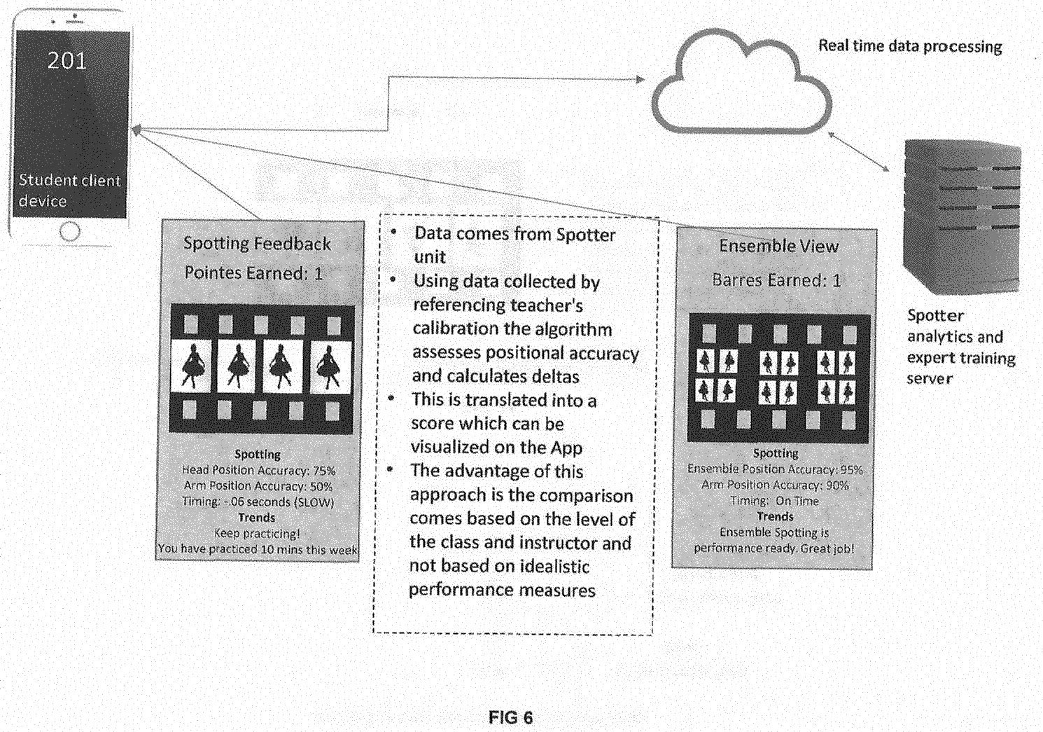

Referring to FIGS. 5 and 6, in an embodiment, system 100 includes circuitry configured to generate a comparison of the position, movement, or timing of a dancer to user-specific target position, user-specific target movement information, or user-specific target timing position. In an embodiment, system 100 includes circuitry configured to generate a comparison of the position, movement, or timing of dancer to one or more levels or standards of performances. In an embodiment, system 100 includes circuitry configured to generate a comparison of the position, movement, or timing of a dancer to physics calculations of an ideal target. In an embodiment, system includes circuitry to generate a visualization of performance and assessment based on the physics. In an embodiment, system 100 includes circuitry configured to generate comparison information including one or more instances of a digital visualization of feedback for a specific dancer and for an ensemble.

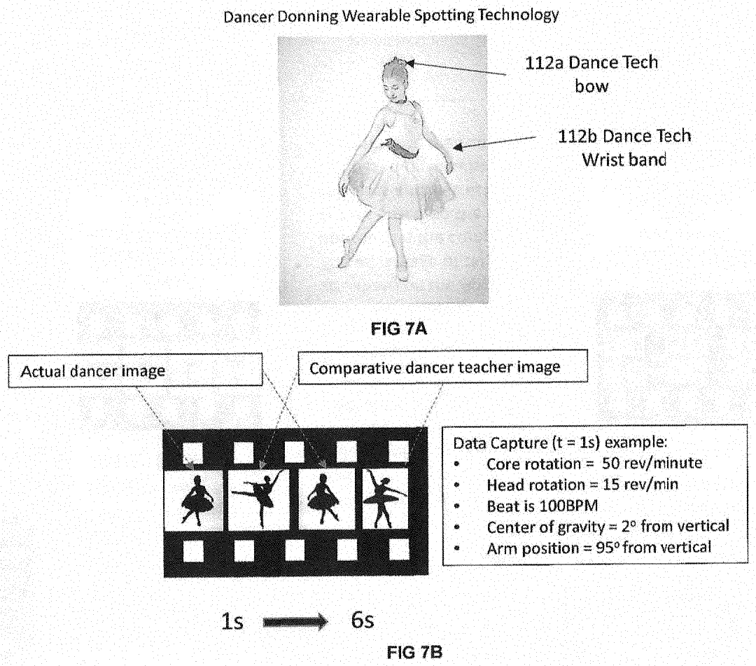

Referring to FIGS. 7A, 7B

In an embodiment, during operation, a dancer will wear one or more spotter elements 112 such as a bow 112a, a clip, a headband in the hair. Further non-limiting examples of spotter elements 112 include wearables, bracelets, or like configured to be worn on the wrist, the arm, or the like. Further non-limiting examples of spotter elements 112 include sash 112b, belts, and the like configured to be worn around the waist. In an embodiment, the spotter elements 112 are incorporate into a dancer's outfit.

In the environment, the figure shows comparison of data at a moment in time of all the measurements generated by the plurality of sensors on the head, body and in the room. This is compared to the expected timing or ambient beat of the music.

### Prophetic Examples

Use Case 1: Dance Turning and Spotting. Dancer wears sensors on head and wrist. The data is collected when the device is “awoken” from sleep mode. Data collection is continuously captured. The data is processed and parsed when uploaded to a processor (residing on a mobile phone, cloud, PC . . . ). The analysis engine will look for key patterns to identify gestures to indicate a turn is about to begin such as hand position, head position and acceleration in sequence of the wrist and head. The algorithm will sync the data from the sensors with sensors that may exist in the studio such as video and sound. The algorithm will then compare the data to a “ruler” set by the dance instructor to give a score as well as provide guidance on how the dancer can improve. This feedback will be provided in the app. This use case is also applicable for other sports such as gymnastics, figure skating, martial arts and many other sports such as baseball, football and basketball where head coordination with the arm motion is required.

Use Case 2: Flexibility, balance and stretching. Dancer wears sensors on head and ankle. The data is collected when the device is “awoken” from sleep mode. Data collection is continuously captured. The data is processed and parsed when uploaded to a processor (residing on a mobile phone, cloud, PC . . . ). The analysis engine will look for key patterns to identify gestures to indicate a stretch is about to begin such as leg position, head position and acceleration in sequence of the ankle and head. The algorithm will sync the data from the sensors with sensors that may exist in the studio such as video and sound. The algorithm will then compare the data to a “ruler” set by the dance instructor to give a score as well as provide guidance on how the dancer can improve. This feedback will be provided in the app. This use case is also applicable for other sports such as gymnastics, figure skating, martial arts and many other sports such as soccer, baseball, football and basketball where head coordination with the leg motion is required.

Use Case 3: Jete or Leaps. Dancer wears sensors on head and wrist or head and ankle. The data is collected when the device is “awoken” from sleep mode. Data collection is continuously captured. The data is processed and parsed when uploaded to a processor (residing on a mobile phone, cloud, PC . . . ). The analysis engine will look for key patterns to identify gestures to indicate a leap is about to begin such as arm or leg position, head position and acceleration in sequence of the wrist or ankle and head. The algorithm will sync the data from the sensors with sensors that may exist in the studio such as video and sound. The algorithm will then compare the data to a “ruler” set by the dance instructor to give a score as well as provide guidance on how the dancer can improve. This feedback will be provided in the app. This use case is also applicable for other sports such as gymnastics, figure skating, martial arts and many other sports such as soccer, baseball, football and basketball where head coordination with the leg motion is required.

Use Case 4: Rhythm or timing. Dancer wears sensors on head and wrist or head and ankle. The data is collected when the device is “awoken” from sleep mode. Data collection is continuously captured. The data is processed and parsed when uploaded to a processor (residing on a mobile phone, cloud, PC . . . ). The analysis engine will look for key movements such as arm or leg position, head position and acceleration in sequence of the wrist or ankle and head. The algorithm will sync the data from the sensors with sensors that may exist in the studio such as video and sound. The algorithm will then compare the data to a “ruler” set by the dance instructor to give a score as well as provide guidance on how the dancer can improve their timing relative the speed of the dance, their teachers movements and the beat. This feedback will be provided in the app. This use case is also applicable for other sports such as gymnastics, figure skating and many other sports where timing mastery is required.

Use Case 5: Ensemble Mode. When a plurality of dancers wears the sensors on head and wrist during a session to learn a new dance. The data is collected when the device is “awoken” from sleep mode. Data collection is continuously captured from each dancers set of sensors. The data is processed and parsed when uploaded to a processor (residing on a mobile phone, cloud, PC . . . ). The analysis engine will look for comparative motion from the group of dancers including timing, spacing, positioning . . . etc. The algorithm will sync the data from the sensors with video and sound. The algorithm will then compare the data to a “ruler” set by the dance instructor to give a score as well as provide guidance on how the dancer can improve their timing relative the speed of the dance, their teachers movements and the beat. This feedback will be provided in the app and overlayed visually with the video. Feedback may be by words or arrows indicating when something is off. This use case is also applicable for other sports such as gymnastics, figure skating and many other sports where uniform motion is required.

Use Case 6: Personalization. To allow inclusiveness the app will allow the teacher to customize the terms used based on their studios common language. This will also allow the system to be flexible and inclusive of different dance styles where the system can be trained to measure different dance forms. This use case is also applicable for all forms of dance (traditional, non-traditional, cultural, etc.)

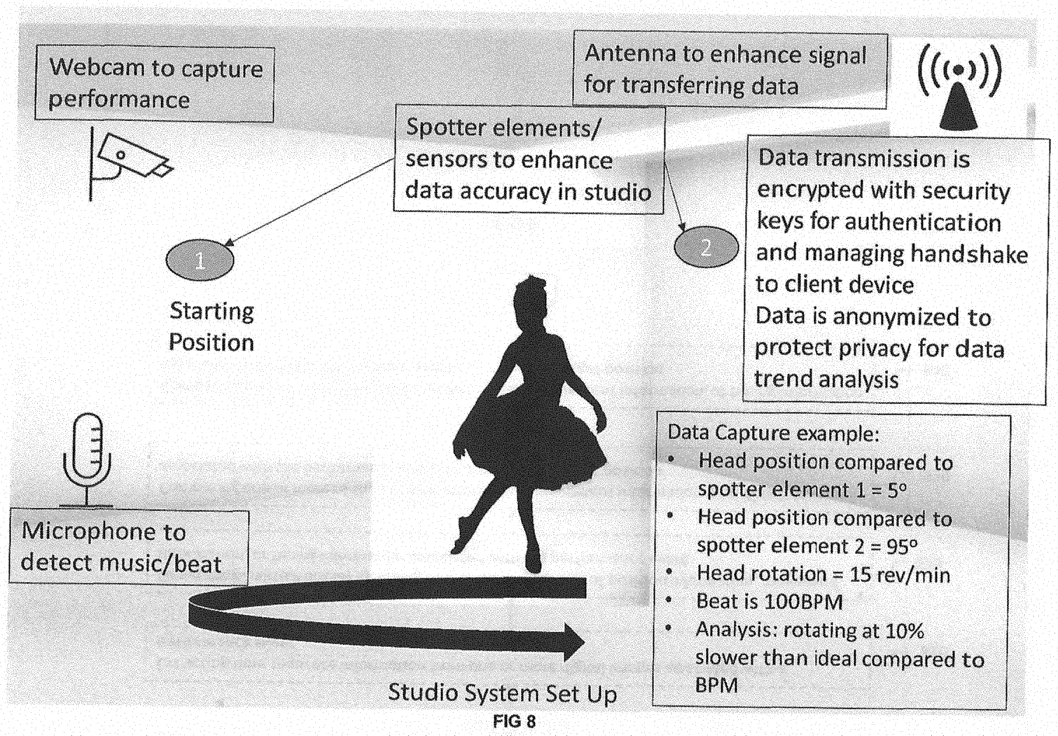

FIG. 8 shows a digital spotting feedback method 800.

At 810, the method 800 includes extracting time sequence information from one or more digital images associated with a performance event.

At 820, the method 800 includes generating a virtual display including one or more instances of position information, movement information, or timing information associated with the performance event.

At 830, the method 800 includes comparing one or more of the position information, movement information, or timing information associated with the performance event to user-specific target position information, user-specific target movement information, or user-specific target timing position.

At 840, the method 800 includes generating a virtual display including one or more instances of a fidelity status associated with the performance event.

FIG. 11 shows a digital spotting feedback method 900.

At 910, the method 900 includes acquiring position information from a plurality of spotter elements.

At 920, the method 900 includes predicting a position of a portion of a body of a user responsive to acquiring position information from a plurality of spotter elements.

At 912, predicting the position of the portion of the body of a user responsive to acquiring position information from a plurality of spotter elements includes determining a relative position of the plurality of spotter elements with respect to each other.

At 914, predicting the position of the portion of the body of a user responsive to acquiring position information from a plurality of spotter elements includes determining movement information based on a change of position of one or more of the plurality of spotter elements.

At 916, predicting the position of the portion of the body of a user responsive to acquiring position information from a plurality of spotter elements includes determining timing information based on a comparison of a change of position of one or more of the plurality of spotter elements and a target change in position rate.

At 920, the method 900 includes generating one or more instances of a first reference position on a virtual display based one or more parameters associated with predicting the position of the portion of the body of the user.

At 930, the method 900 includes generating posture information or gesture information responsive to acquiring change in position information from the plurality of spotter elements.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include, but are not limited to, physically mateable, physically interacting components, wirelessly interactable, wirelessly interacting components, logically interacting, logically interactable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the type of signal-bearing medium used to carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically, a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), the various operations may be performed in orders other than those that are illustrated, or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A system, comprising:
a spotter unit configured to generate a time sequence of pixel images associated with a performance event and to generate position information, movement information, or timing information associated with the performance event; and
a trainer unit configured to compare the position, movement, or timing information associated with the performance event to user-specific target position information, user-specific target movement information, or user-specific target timing position information, and to provide one or more instances of a fidelity status associated with the performance event.

2. The system of claim 1, wherein the spotter unit includes processing circuitry operably coupled to a plurality of spotter elements adapted to be worn on a body of a user.

3. The system of claim 2, wherein the spotter unit includes processing circuitry operably coupled to a plurality of spotter elements, wherein the plurality of spotter elements includes one or more accelerometers, global positioning sensors, gyroscopes, inclinometers, inertial sensors, magnetometers, moment of inertia sensors, motion sensors, or nodes.

4. The system of claim 2, wherein the spotter unit includes processing circuitry operably coupled to a plurality of spotter elements, wherein the plurality of spotter elements includes one or more of a headband including one or more onboard sensors, a wristband including one or more onboard sensors, a leg band including one or more onboard sensors, or an article of clothing including one or more onboard sensors.

5. The system of claim 2, wherein the spotter unit includes processing circuitry operably coupled to a plurality of spotter elements, wherein the plurality of spotter elements includes one or more haptic or acoustic elements.

6. The system of claim 1, wherein the spotter unit includes processing circuitry operably coupled to a plurality of spotter elements adapted to be worn on a body of a user, the spotter unit configured to acquire position information from the plurality of spotter elements.

7. The system of claim 1, wherein the spotter unit includes processing circuitry operably coupled to a plurality of spotter elements adapted to be worn on a body of a user, the spotter unit configured to determine a position of a portion of the body of a user relative to one or more of the plurality of spotter elements and to generate one or more instances of a first reference position on a virtual display.

8. The system of claim 1, wherein the spotter unit is configured to acquire position information from the plurality of spotter elements and to determine a relative position of the plurality of spotter elements with respect to each other.

9. The system of claim 1, wherein the spotter unit is configured to acquire position information from the plurality of spotter elements and to determine movement information based on a change of position of one or more of the plurality of spotter elements.

10. The system of claim 1, wherein the spotter unit is configured to acquire position information from the plurality of spotter elements and to determine timing information based on a comparison of a change of position of one or more of the plurality of spotter elements and a target change in position rate.

11. The system of claim 1, wherein the spotter unit includes processing circuitry configured to acquire movement information from a plurality of spotter elements adapted to be worn on a body of a user.

12. The system of claim 1, wherein the spotter unit includes processing circuitry configured to acquire timing information from a plurality of spotter elements adapted to be worn on a body of a user.

13. The system of claim 1, wherein the spotter unit is configured to acquire position information from the plurality of spotter elements and to generate posture or gesture information associated with the performance event based on the position information from the plurality of spotter elements.

14. The system of claim 1, wherein the spotter unit is configured to use information from one or more accelerometers, global positioning sensors, gyroscopes, inclinometers, inertial sensors, magnetometers, moment of inertia sensors, motion sensors, or nodes to generate location and orientation data of a user captured in the time sequence of pixel images associated with a performance event.

15. The system of claim 1, wherein the trainer unit is configured to generating an electrical control signal for controlling actuation of the at least one haptic element or acoustic element associated with at least one of the plurality of spotter elements based on the comparison of the position, movement, or timing information associated with the performance event to user-specific target position, user-specific target movement information, or user-specific target timing position.

16. A digital spotting feedback method, comprising:
extracting time sequence information from one or more digital images associated with a performance event; and
generating a virtual display including one or more instances of position information, movement information, or timing information associated with the performance event.

17. The digital spotting feedback method of claim 16, further comprising:
comparing one or more of the position information, movement information, or timing information associated with the performance event to user-specific target position information, user-specific target movement information, or user-specific target timing position; and
generating a virtual display including one or more instances of a fidelity status associated with the performance event.

18. A method, comprising:
acquiring position information from a plurality of spotter elements;
predicting a position of a portion of a body of a user responsive to acquiring position information from a plurality of spotter elements; and
generating one or more instances of a first reference position on a virtual display based one or more parameters associated with predicting the position of the portion of the body of the user.

19. The method of claim 19, wherein predicting the position of the portion of the body of a user responsive to acquiring position information from a plurality of spotter elements includes determining a relative position of the plurality of spotter elements with respect to each other.

20. The method of claim 19, wherein predicting the position of the portion of the body of a user responsive to acquiring position information from a plurality of spotter elements includes determining movement information based on a change of position of one or more of the plurality of spotter elements.

21. The method of claim 19, wherein predicting the position of the portion of the body of a user responsive to acquiring position information from a plurality of spotter elements includes determining timing information based on a comparison of a change of position of one or more of the plurality of spotter elements and a target change in position rate.

22. The method of claim 19, further comprising:
generating one or more instances of a first reference position on a virtual display based one or more parameters associated with predicting the position of the portion of the body of the user

23. The method of claim 19, further comprising:
generating posture information or gesture information responsive to acquiring change in position information from the plurality of spotter elements.
